(19) United States
(12) Patent Application Publication
(10) Pub. No.: US 2015/0065622 A1
(43) Pub. Date: Mar. 5, 2015

(54) STABILIZED POLYCARBONATE/ACRYLONITRILE/STYRENE/ACRYLIC ESTER MOULDING COMPOUNDS

(71) Applicants: Rolf Minkwitz, Mannheim (DE); Alexander Ludwig, Heidelberg (DE); Kerim Wewer, Mannheim (DE); Rainer Huebner, Stetten (DE)

(72) Inventors: Rolf Minkwitz, Mannheim (DE); Alexander Ludwig, Heidelberg (DE); Kerim Wewer, Mannheim (DE); Rainer Huebner, Stetten (DE)

(73) Assignee: STYROLUTION GMBH, Frankfurt am Main (DE)

(21) Appl. No.: 14/347,424

(22) PCT Filed: Sep. 3, 2012
(86) PCT No.: PCT/EP2012/067075

§ 371 Date: Oct. 22, 2014

(30) Foreign Application Priority Data
Sep. 29, 2011 (EP) 11183226.7

(51) Int. Cl. C08L 69/00

(52) U.S. Cl. CPC C08L 69/00; C08L 2201/08; C08L 2205/03; C08L 2201/02
USPC 524/100; 524/102

(57) ABSTRACT

Thermoplastic molding compositions comprising the following components:
a) 3 to 91.7 wt % of at least one aromatic polycarbonate, as component A
b) 3 to 91.7 wt % of one or more styrene copolymers, as component B
c) 3 to 91.7 wt % of one or more impact-modifying grafted rubbers without olefinic double bonding in the rubber plase, as component C, and also
d) 0.2 to 0.9 wt % of a compound of formula (I), as component D:

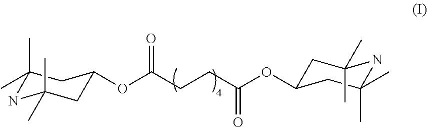

e) 0 to 0.9 wt % of a mixture of formula (II), as component E:

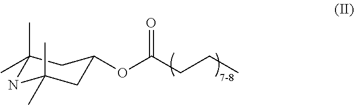

n=2 to 20
f) 0 to 0.9 wt % of a triazine stabilizer, and also, optionally further components,
   with the proviso that when component E amounts to 0 wt %, at least one further stabilizer is present in an amount of 0.01 to 0.9 wt %, have good weathering properties.

The present invention relates to thermoplastic molding compositions comprising at least a polycarbonate, a styrene copolymer and impact-modifying grafted rubber without olefinic double bonding in the rubber phase.

Stabilized thermoplastic molding compositions of various kinds are well known and are widely used because their performance characteristics—good weathering resistance, in particular—are favorable for many applications. Polyblends of polycarbonate and ASA (acrylonitrile/styrene/acrylic ester polymers) have excellent mechanical properties. A person skilled in the art will find details of these molding compositions, for example, in L. Bottenbruch, Kunstoff-Handbuch, Volume 3/2 “Engineering polyblends” [in German], Hanser Verlag, Munich 1993.

EP-A 1 263 855 discloses, for example, stabilized molding compositions which, in addition to a polyethylene or polypropylene or a copolymer thereof, may further comprise compounds of hereinbelow recited formulae (I), (II), (Ill), (IV), (V) or (VI) of the present invention in combination with an acrylate rubber-modified vinylaromatic copolymer (ASA, acrylonitrile/styrene/acrylate) or polycarbonate in amounts up to 1.5%. These molding compositions are disadvantageous because they lack heat resistance.

U.S. Pat. No. 4,692,486 discloses stabilizer mixtures comprising compounds of formulae (I) and (III) of the present invention for polypropylene, polyurethane and polystyrene, wherein the individual stabilizer components are each employed at not more than 0.1 wt %. Again, these mixtures are disadvantageous because the molding compositions lack heat resistance.

DE-A 103 16 198 discloses stabilizer mixtures for different types of thermoplastic polymers, such as polypropylene for example. The stabilizer mixtures are ternary mixtures. A multiplicity of possible generic and specific compounds are described for each of the three components of the stabilizer mixture. Stabilizer mixtures comprising compounds of formulae (I), (II) and (III) of the present invention is described as merely one of many possibilities.

Each of the three stabilizer components may preferably be present in amounts of 0.05 to 1 wt %, based on the organic material. These mixtures are disadvantageous because the multi-axial toughness declines severely during weathering.

It is the object of the present invention to provide improved molding compositions on the basis of polycarbonate and acrylonitrile/styrene/acrylate molding compositions.

The present invention accordingly provides novel and improved thermoplastic molding compositions comprising (or even consisting of) the following components:
a) 3 to 91.7 wt % of at least one aromatic polycarbonate, as component A
b) 3 to 91.7 wt % of one or more styrene copolymers, as component B
c) 3 to 91.7 wt % of one or more impact-modifying grafted rubbers without olefinic double bonding in the rubber phase, as component C
d) 0.2 to 0.9 wt % of a compound of formula (I), as component D:

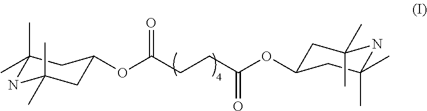

e) 0 to 0.9 wt % of a mixture of formula (II), as component E,

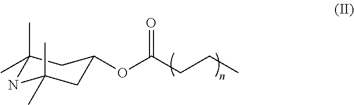

n=2 to 20
where the following substance is often used,

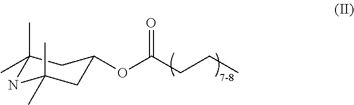

f) 0 to 0.9 wt % of a compound of formula (III), as component F:

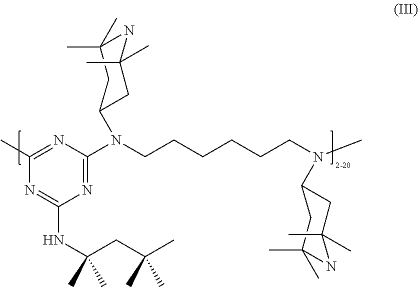

or 0 to 0.9 wt % of a compound of formula (IV):

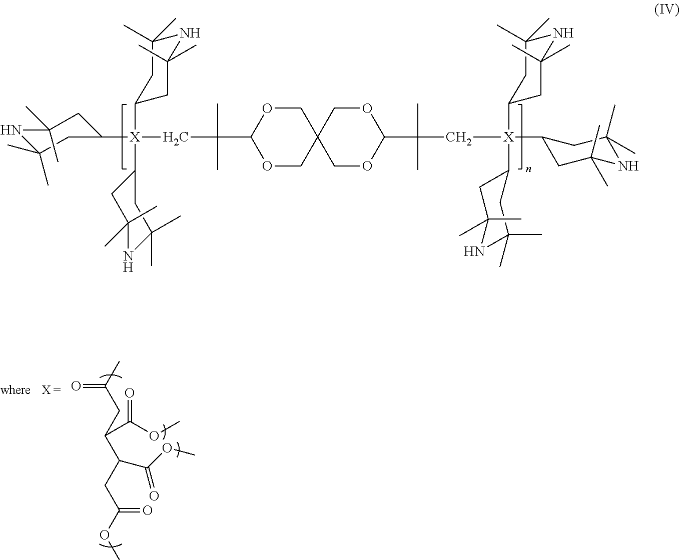

and n is 2 to 20,
   or 0 to 0.9 wt % of a compound of formula (V):

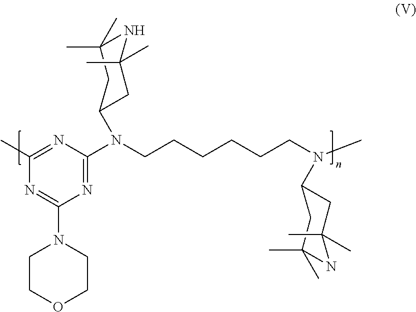

where n is 2 to 20,
   or 0 to 0.9 wt % of a compound of formula (VI):

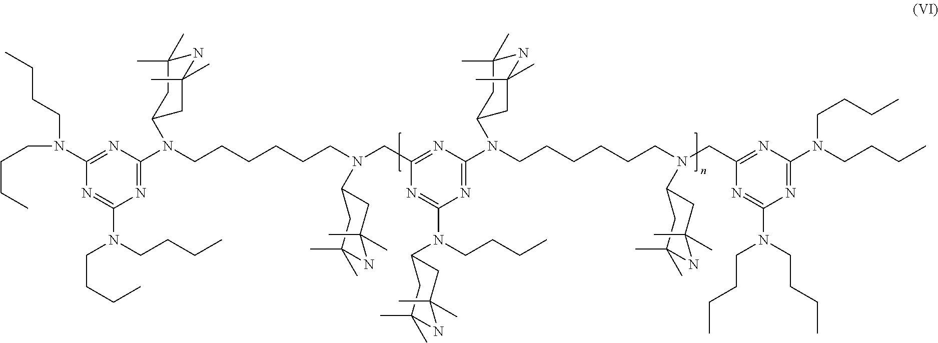

where n is 2 to 20;
g) 0 to 25 wt % of at least one halogen-free phosphorus compound G
h) 0 to 10 wt % of one or more added-substance materials other than components D, E, F and G, as component H, and
i) 0 to 40 wt % of fibrous or particulate fillers, as component I,
   with the proviso that when component E amounts to exactly 0 wt % (i.e., no component E is present), at least one of the components of formulae (III), (IV), (V) or (VI) is present in an amount of 0.01 to 0.9 wt %, preferably 0.1 to 0.9 wt % and more preferably 0.2 to 0.8 wt %, wherein the wt % are each based on the overall weight of components A to I, and these add up to 100 wt %.

Preference is given to those molding compositions which comprise a stabilizer component D and a stabilizer component E and optionally a further stabilizer component (e.g., F). Preference is also given to those molding compositions which comprise from 0.2 to 0.9 wt % of a stabilizer component E.

The invention further provides a thermoplastic molding composition in which the swelling index of component C is in the range from 6 to 20.

The invention further provides a thermoplastic molding composition in which component B comprises a copolymer of acrylonitrile, styrene and/or α-methylstyrene, phenylmaleimide, methyl methacrylate or mixtures thereof.

The invention further provides a thermoplastic molding composition in which component C comprises a mixture of an acrylate-styrene-acrylonitrile (ASA) graft polymer comprising 55 to 80 wt %, based on C, of an elastomer-crosslinked acrylic ester polymer C1 and 45 to 20 wt %, based on C, of a graft sheath C2 formed from a vinylaromatic monomer and one or more polar, copolymerizable, ethylenically unsaturated monomers, optionally a further copolymerizable, ethylenically unsaturated monomer in a weight ratio of from 80:20 to 65:35.

The invention further provides a thermoplastic molding composition in which in component C component C1 comprises from 0.01 to 20 wt %, preferably from 0.1 to 5 wt %, of a crosslinking monomer, preferably butylene diacrylate, divinylbenzene, butaynediol dimethacrylate, trimethylolpropane tri(meth)acrylate, diallyl methacrylate, diallyl maleate, diallyl fumarate, triallyl methacrylate, triallyl isocyanurate, more preferably diallyl phthalate, allyl methacrylate and/or dihydrodicyclopentadienyl acrylate.

The invention further provides a thermoplastic molding composition in which the average particle diameter of component C is between 50 to 1200 nm.

The invention further provides a thermoplastic molding composition in which the weight ratio of components D and E is in the range from 4:1 to 1:1 and the weight ratio of components E and F is in the range from 2:1 to 0.5:1.

The invention further provides thermoplastic molding compositions which can comprise from 0 to 1.5 wt % of phthalic ester or adipic ester.

The invention further provides a thermoplastic molding composition in which component C1 comprises from 2 to 99 wt % of butyl acrylate.

The invention further provides a thermoplastic molding composition in which the vinylaromatic component in C2 comprises either styrene or α-methylstyrene.

The invention further provides a thermoplastic molding composition in which the ethylenically unsaturated component in C2 comprises acrylonitrile and/or alkyl methacrylates and/or alkyl acrylates having C₁-C₈ alkyl.

The invention further provides a thermoplastic molding composition in which component C comprises a grafted rubber in monomodal or bimodal particle size distribution.

Further provided is a process for producing a thermoplastic molding composition as described above, said process being characterized in that components A to D and, optionally, components E to I are mutually mixed with one another in any desired order at temperatures of 100 to 300° C. and a pressure of 1 to 50 bar, then kneaded and extruded.

The process for producing a thermoplastic molding composition may be carried out by first premixing a portion of component C with a portion of component B to form a masterbatch in the ratio of from 1:1 to 1:2 and then mixing said masterbatch with further components A to D and, optionally, components E to I to form the thermoplastic molding composition.

The invention further provides for the use of thermoplastic molding compositions as described above for producing molded articles, self-supporting films or sheets, or fibers. The use of the thermoplastic molding compositions for producing molded articles for automotive components or parts of electronic equipment is of particular advantage.

The invention also provides molded articles, fibers or self-supporting films or sheets from a thermoplastic molding composition as described above.

The specific selection of the individual components and of their specific proportions is essential to the present invention and endows the molding compositions of the present invention with an improved weathering resistance, i.e., an improved heat, light and/or oxygen resistance, over the known stabilized molding compositions.

The molding compositions, articles, processes and uses provided by the present invention will now be more particularly described. The molding compositions of the present invention each comprise, based on the overall weight of components A, B, C, D, E, F, G and I, which totals all together 100 wt %,
a) 3 to 91.7 wt %, preferably 30 to 75 wt %, of at least one aromatic polycarbonate, as component A,
b) 3 to 91.7 wt %, preferably 10 to 30 wt %, of component B,
c) 3 to 91.7 wt %, preferably 4 to 20 wt %, of component C,
d) 0.2 to 0.9 wt %, preferably 0.2 to 0.7 wt %, more preferably 0.3 to 0.6 wt % of component D,
e) 0 to 0.9 wt %, preferably 0.2 to 0.7 wt %, more preferably 0.2 to 0.4 wt % of component E, with the proviso that when component E amounts to 0 wt % (i.e., no component E is present), at least one of the components of the formulae (III), (IV), (V) or (VI) is present in an amount of 0.01 to 0.9 wt %, preferably 0.1 to 0.9 wt %, more preferably 0.2 to 0.8 wt %;
f) 0 to 0.9 wt %, preferably 0.1 to 0.9 wt %, more preferably 0.2 to 0.8 wt % of component F,
g) 0 to 25 wt %, preferably 0 to 15 wt %, more preferably 0 to 10 wt % of component G,
h) 0 to 10 wt %, preferably 0 to 8 wt %, more preferably 0 to 5 wt % of component H, and
i) 0 to 40 wt %, preferably 0 to 25 wt %, more preferably 0 to 15 wt % of component I.

The weight ratio of component D to component E is generally in the range from 4:1 to 0.25:1, preferably in the range from 4:1 to 1:1 and more preferably in the range from 3:1 to 1:1. The weight ratio of component E to component F is often in the range from 2:1 to 0.5:1.

The molding compositions often comprise 30 to 75 wt % of component A, 10 to 30 wt % of component B, 4 to 20 wt % of component C and 0.3 to 0.6 wt % of component D.

The components used are defined hereinbelow:

### Component A:

Component A is comprised in the molding compositions according to the present invention in an amount of 3 to 91.7 wt %, preferably from 30 to 75 wt %, often 50 to 70 wt %.

Component A preferably comprises halogen-free polycarbonates. Suitable halogen-free polycarbonates include, for example, those based on diphenols of general formula (VII):

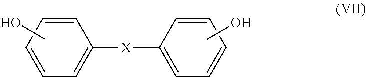

where X is selected from the group consisting of a single bond, a C₁-C₃ alkylene group, a C₂-C₃ alkylidene group, a C₃-C₆ cycloalkylidene group, —S— and —SO₂—.

Examples of preferred diphenols of formula (VII) are hydroquinone, resorcinol, 4,4′-dihydroxyphenyl, 2,2-bis(4-hydroxyphenyl)propane, 2,4-bis(4-hydroxyphenyl)-2-methylbutane, 1,1-bis(4-hydroxyphenyl)cyclohexane. Particular preference is given to 2,2-bis(4-hydroxyphenyl)propane and 1,1-bis(4-hydroxyphenyl)cyclohexane and also 1,1-bis(4-hydroxyphenyl)-3,3,5-trimethylcyclohexane.

Not only homopolycarbonates but also copolycarbonates are useful as component A in that the copolycarbonates of bisphenol A are preferred as well as the bisphenol A homopolycarbonate. The polycarbonates which are suitable may have a linear construction or else be branched in a known manner, but preferably by incorporation of 0.05 to 2 mol %, based on the sum total of diphenols used, of at least one trifunctional compound, for example those having three or more than three phenolic OH groups.

Polycarbonates that will prove particularly advantageous have relative viscosities ηᵣₑₗ of 1.1 to 1.5, in particular 1.2 to 1.4. This corresponds to average molecular weights Mw (weight-average value) of 10 000 to 200 000, preferably of 15 000 to 80 000, or viscosity numbers of 20 to 100 ml/g, in particular 40 to 80 ml/g, measured to German standard specification DIN 53727 on a 0.5 wt % solution in methylene chloride at 23° C.

The diphenols of general formula (VII) are known per se or obtainable by known methods. The polycarbonates are obtainable for example by reacting the diphenols with phosgene by the phase interface process or with phosgene by the homogeneous-phase process (the so-called pyridine process), in which case the particular viscosity number to be set (and hence the molecular weight) is attained in a known manner via an appropriate amount of known chain terminators. With regard to the polydiorganosiloxane-containing polycarbonates which can likewise be used, see for instance DE-A-33 34 782.

Suitable chain terminators for forming the polycarbonates include, for example, phenol, p-t-butylphenol but also long-chain alkylphenols such as 4-(1,3-tetramethylbutylbutyl)phenol, as described in DE-A-28 42 005, or monoalkylphenols or dialkylphenols with altogether 8 to 20 carbon atoms in the alkyl substituents, as described in DE-A-35 06 472, such as p-nonylphenol, 3,5-di-t-butylphenol, p-t-octylphenol, p-dodecylphenol, 2-(3,5-dimethylheptyl)phenol and 4-(3,5-dimethylheptyl)phenol.

Halogen-free polycarbonates for the purposes of the present invention are polycarbonates constructed from halogen-free diphenols, halogen-free chain terminators and optionally halogen-free branching agents, although the presence of very low ppm quantities (e.g., 5 ppm) of saponifiable chlorine, resulting for example from the synthesis of the polycarbonates with phosgene by the phase interface process, shall not be regarded as halogen-containing for the purposes of the present invention. Such polycarbonates with ppm contents of saponifiable chlorine are halogen-free polycarbonates for the purposes of the present invention.

It is preferable to use the polycarbonates which are employed in the experimental section.

### Component B:

Component B of the thermoplastic molding compositions according to the present invention comprises one or more styrene copolymers. Component B is comprised in the molding compositions in an amount of 3 to 91.7 wt %, preferably 10 to 30 wt %, often 15 to 21 wt %.

Any suitable comonomers may be present in these copolymers as well as styrene. It is preferable for a styrene-acrylonitrile copolymer, an alpha-methylstyrene-acrylonitrile copolymer or an N-phenylmaleimide-styrene copolymer to be concerned.

Any styrene-acrylonitrile, α-methylstyrene-acrylonitrile, N-phenylmaleimide-acrylonitrile copolymers, and mixtures thereof, that are known to a person skilled in the art and are described in the literature can in principle be used as component B provided their mixtures have a viscosity number VN (as measured to German standard specification DIN 53727 at 25° C. on a 0.5 wt % solution in dimethylformamide; this method of measurement also holds for any hereinbelow recited viscosity numbers VN) of not more than 85 ml/g.

Preferred components B are constructed from 50 to 90 wt %, preferably 60 to 85 wt %, in particular 70 to 83 wt %, of styrene and 10 to 50 wt %, preferably 15 to 40 wt %, in particular 17 to 30 wt %, of acrylonitrile and also 0 to 5 wt %, preferably 0 to 4 wt %, in particular 0 to 3 wt %, of further monomers, wherein the wt % are each based on the weight of the components in copolymer B and add up to 100 wt %.

Preferred components B are further constructed from 50 to 90 wt %, preferably 60 to 80 wt %, in particular 65 to 78 wt %, of α-methylstyrene and 10 to 50 wt %, preferably 20 to 40 wt %, in particular 22 to 35 wt %, of acrylonitrile and also 0 to 5 wt %, preferably 0 to 4 wt %, in particular 0 to 3 wt %, of further monomers, wherein the wt % are each based on the weight of the components in copolymer B and add up to 100 wt %.

Similarly preferred components B are mixtures of these styrene-acrylonitrile copolymers and α-methylstyrene-acrylonitrile copolymers with N-phenylmaleimide-styrene-acrylonitrile terpolymers or N-phenylmaleimide-styrene copolymers.

The further monomers referred to above can be any copolymerizable monomers, for example p-methylstyrene, t-butylstyrene, vinylnaphthalene, alkyl acrylates and/or alkyl methacrylates, for example those with C₁-C₈ alkyl, N-phenylmaleimide and mixtures thereof.

The copolymers of component B are obtainable by known methods. For instance, they are obtainable by free-radical polymerization, in particular by emulsion, suspension, solution or bulk polymerization. They have viscosity numbers in the range from 40 to 160 ml/g, which corresponds to average molecular weights Mw (weight-average value) of 40 000 to 2 000 000 g/mol.

### Component C:

Component C comprises elastomeric graft copolymers of vinylaromatic compounds, in particular of styrene, and vinyl cyanides, in particular acrylonitrile, on poly(alkyl acrylate) rubbers. Component C is comprised in the molding compositions from 3 to 91.7 wt %, preferably from 4 to 20 wt %, often from 10 to 20 wt %.

One way to characterize the extent of the crosslinking in crosslinked particles of polymer is to measure the swelling index SI which, according to the literature, is a measure of the degree to which a more or less crosslinked polymer is swellable by a solvent. Methyl ethyl ketone and toluene are examples of customary swelling agents. Graft copolymer C of the molding compositions according to the present invention typically has an SI in the range SI=10 to 60. The SI is preferably in the range from 6 to 18 and more preferably in the range from 7 to 15 (in toluene).

To determine the swelling index, an aqueous dispersion of graft copolymer C is dried at 80° C. overnight on a metal sheet under slightly reduced pressure (600 to 800 mbar) and nitrogen, leaving a film about 2 mm in thickness. A 1 cm² slice is then cut off and swollen overnight in 50 ml of toluene (or methyl ethyl ketone) in a penicillin bottle. Supernatant toluene is removed by suction, and the swollen film is weighed and dried at 80° C. overnight. The weight of the dried film is determined. The swelling index is calculated by dividing the weight of the swollen gel by the weight of the dried gel.

In one preferred embodiment, the elastomeric graft copolymer C is constructed from:
C1 1 to 99 wt %, preferably 55 to 80 wt %, in particular 55 to 65 wt %, of a particulate grafting base C1, having a glass transition temperature below 0° C., and
C2 99 to 1 wt %, preferably 45 to 20 wt %, in particular 45 to 35 wt %, of a graft C2, having a glass transition temperature above 30° C.,
   based on C.

Component C1 therein is constructed from:
C11 60 to 99.98 wt %, preferably 80 to 99.9 wt %, of at least one C₁₋₈alkyl ester of acrylic acid, preferably C₄₋₈ alkyl acrylates, in particular n-butyl acrylate and/or 2-ethylhexyl acrylate, as component C-11,
C12 0.01 to 20 wt %, preferably 0.1 to 5 wt %, of at least one polyfunctional crosslinking monomer, preferably butylene diacrylate, divinylbenzene, butaynediol dimethacrylate, trimethylolpropane tri(meth)acrylate, diallyl methacrylate, diallyl maleate, diallyl fumarate, triallyl methacrylate, triallyl isocyanurate, more preferably diallyl phthalate, allyl methacrylate and/or dihydrodicyclopentadienyl acrylate (“DCPA”), and
C13 0.01 to 39.99 wt %, preferably 0 to 19.9 wt %, of monomers forming hard polymers, such as vinyl acetate, (meth)acrylonitrile, styrene, substituted styrene, methyl methacrylate or vinyl ether.

Component C2 therein is constructed from:
C-21 40 to 100 wt %, preferably 65 to 85 wt % of a vinylaromatic monomer, in particular of styrene, of α-methylstyrene or of N-phenylmaleimide, and
C-22 0 to 60 wt %, preferably 15 to 35 wt % of a polar copolymerizable ethylenically unsaturated monomer, in particular of acrylonitrile, of (meth)acrylic ester or of methacrylonitrile.

Component C comprises a graft copolymer comprising a grafting base C1 and at least one graft C2. Graft copolymer C may have a more or less perfectly developed core-shell construction (grafting base C1 is the core, graft C2 is the shell), but it is also possible for graft C2 to enclose/cover grafting base C1 only incompletely or alternatively for grafting base C1 to be wholly or partly interpenetrated by graft C2.

Grafting base C1 in one embodiment of the invention may comprise a so-called core, which may be formed from a soft elastomeric polymer or a hard polymer; in various embodiments where grafting base C1 comprises a core, the core is preferably formed from a hard polymer, in particular polystyrene or a styrene copolymer. Such grafting cores and their method of making are known to a person skilled in the art and are described for example in EP-A 535 456 and EP-A 534 212.

It is also possible to employ two or more grafting bases C1 that differ from each other, for example, in their composition or in particle size. Such mixtures of different grafting bases are obtainable in a conventional manner, for example by producing two or more rubber lattices separately and mixing the corresponding dispersions; precipitating the moist rubbers separately from the corresponding dispersions and mixing them, for example, in an extruder; or performing the entire work-up of the corresponding dispersions separately and then mixing the grafting bases obtained.

Graft copolymer C may include at a point between grafting base C1 and graft C2 one or more further grafts, or grafted sheaths or shells, for example having different lineups of monomer. Preferably, however, graft copolymer C aside from graft C2 includes no further grafts or grafted sheaths or shells.

The polymer of grafting base C1 typically has a glass transition temperature below 0°, preferably a glass transition temperature below (−20°) C., in particular below (−30°) C. A polymer formed from the monomers which form graft C2 typically has a glass transition temperature of more than 30° C., in particular more than 50° C. (each determined to German standard specification DIN 53765).

Graft copolymers C typically have an average particle size d₅₀ in the range from 50 to 1200 nm, preferably in the range from 50 to 800 nm and more preferably in the range from 50 to 600 nm. These particle sizes are obtainable by using average particle sizes d₅₀ in the range from 50 to 1000 nm, preferably in the range from 50 to 700 nm and more preferably in the range from 50 to 500 nm as grafting base C1. In one embodiment of the invention, the particle size distribution is monomodal.

In a further embodiment of the invention, the particle size distribution of component C is bimodal in that from 60 to 90 wt % is of an average particle size in the range from 50 to 200 nm and from 10 to 40 wt % is of an average particle size in the range from 200 to 800 nm, based on the overall weight of component C. The particle size distribution and the average particle size reported herein are determined from the cumulative mass-based distribution. These average particle sizes and the further average particle sizes recited in the context of the present invention are in all cases the weight averages of the particle sizes as determined via HDC (see W. Wohlleben and H. Schuch in Measurement of Particle Size Distribution of Polymer Latexes, 2010, Editors: Luis M. Gugliotta and Jorge R. Vega, pp. 130 to 153).

Graft copolymers C are obtainable by graft polymerization of components C-21 and C-22 onto at least one of grafting bases C1 recited above. Emulsion polymerization, solution polymerization, bulk polymerization and suspension polymerization are suitable methods of making graft copolymers C. Graft copolymers C are preferably made by free-radical emulsion polymerization in the presence of lattices of component C1 at temperatures of 20 to 90° C. by using water-soluble or oil-soluble initiators such as peroxodisulfate or benzyl peroxide, or by means of redox initiators. Redox initiators are also useful for polymerization below 20° C.

Suitable methods of polymerization are described in WO 02/10222, DE-A 28 26 925, DE-A 31 49 358 and DE-C 12 60 135. The grafts are preferably constructed by emulsion polymerization as described in DE-A 32 27 555, DE-A 31 49 357, DE-A 31 49 358, DE-A 34 14 118. The defined adjustment of the average particle sizes to the range from 50 to 1200 nm is preferably made according to the methods described in DE-C 12 60 135 and DE-A 28 26 925, and/or Applied Polymer Science, volume 9 (1965), page 2929.

Usage of polymers having different particle sizes is known, for example, from DE-A-28 26 925 and U.S. Pat. No. 5,196,480. In the method described in DE-B-12 60 135, the first step comprises preparing grafting base C1 by polymerizing the C-11 acrylic ester(s) used in one embodiment of the invention and the C-12 compound acting as crosslinking and/or grafting reagent, optionally together with further monoethylenically unsaturated monomers C-13, in an aqueous emulsion in a conventional manner at temperatures between 20 and 100° C., preferably between 50 and 90° C.

Customary emulsifiers can be used, examples being alkali metal salts of alkyl- and alkylaryl sulfonic acids, alkyl sulfates, fatty alcohol sulfonates, salts of higher fatty acids having 10 to 30 carbon atoms or resin soaps. Preference is given to using the sodium salts of alkyl sulfonates or fatty acids having 10 to 18 carbon atoms. In one embodiment, emulsifiers are employed in amounts of 0.5 to 5 wt %, in particular of 0.7 to 2 wt %, based on the monomers employed in the preparation of grafting base C1. The weight ratio of water to monomers is generally in the range from 4:1 to 0.6:1.

Useful polymerization initiators include particularly the customary persulfates, for example potassium persulfate. Redox systems can also be employed, however. The initiators are generally employed in amounts of 0.1 to 1 wt %, based on the monomers used in the preparation of grafting base C1. Useful polymerization assistants further include the customary buffering substances to adjust the pH to the preferred range from 6 to 9, such as sodium bicarbonate and sodium pyrophosphate, and also from 0 to 3 wt % of a molecular weight controller, such as mercaptans, terpinols or dimeric α-methylstyrene.

Precise polymerization conditions, in particular emulsifier type, feed modus and quantity, are specifically determined within the above-specified ranges such that the resultant latex of crosslinked acrylic ester polymer C1 has a d₅₀ value in the range from 50 to 1000 nm, preferably in the range from 50 to 700 nm and more preferably in the range from 50 to 500 nm. And the particle size distribution of the latex shall preferably be narrow, with a polydispersity index <0.75, in line with W. Machtle and L. Borger, Analytical Ultracentrifugation of Polymers and Nanoparticles, (Springer, Berlin, 2006).

To form graft polymer C, one embodiment of the invention may comprise a subsequent step wherein the latex thus obtained for crosslinked acrylic ester polymer C1 is present as a monomer mixture of component C-21, preferably styrene, component C-22, preferably acrylonitrile and/or a (meth)acrylic ester, and optionally further unsaturated monomers is polymerized. Monomers C-21, C-22 and optionally further unsaturated monomers may be added to this polymerization individually or in admixture with one another. One possible example is to graft initially styrene alone and thereafter a mixture of styrene and acrylonitrile. It is advantageous for this graft copolymerization onto the crosslinked acrylic ester polymer grafting base to be again carried out in aqueous emulsion under the customary conditions as described above.

The graft copolymerization may be conveniently carried out in the same system as the emulsion polymerization to form grafting base C1, in which case further emulsifier and initiator can be added, if necessary. The monomer mixture to be grafted onto the grafting base in one embodiment of the invention may be added to the reaction mixture all at once, batchwise in two or more stages—for example to construct two or more grafts—or preferably continuously during the polymerization. The graft copolymerization of the mixture of components C-21, C-22 and optionally further monomers in the presence of acrylic ester polymer C1 to be crosslinked is conducted such that graft copolymer C has a degree of grafting in the range from 10 to 70 wt %, preferably in the range from 20 to 60 wt % and in particular in the range from 30 to 55 wt %, based on the overall weight of component C.

Since the grafting yield of a graft copolymerization is never 100%, a somewhat larger amount of the monomer mixture of C-21, C-22 and optionally further monomers should advantageously be used in the graft copolymerization than corresponds to the desired degree of grafting. Controlling the grafting yield in a graft copolymerization and thus the degree of grafting for final graft copolymer C is familiar to a person skilled in the art and may be accomplished for example via the monomer feed rate or via admixture of chain transfer agents (Chauvel, Daniel, ACS Polymer Preprints 15 (1974), pages 329 to 333).

An emulsion graft copolymerization will generally give rise to from 5 to 15 wt %, based on the graft copolymer, of free, ungrafted copolymer of components C-21, C-22 and optionally the further monomers. The proportion of graft copolymer C in the polymerization product obtained in the graft copolymerization can be determined for example by the method described in US 2004/0006178.

In further embodiments of the processes according to the present invention, grafting base C1 may be formed in the presence of seed particles and/or an agglomeration step may be carried out after formation of grafting base C1 and before application of graft C2. These two processing options are known to a person skilled in the art and/or described in the literature, and are chosen for example in order that particle sizes and particle size distributions may be adjusted in a specific manner.

The d₅₀ size of seed particles is generally in the range from 10 to 200 nm, preferably in the range from 10 to 180 nm and more preferably in the range from 10 to 160 nm. The employment of seed particles having a particle size distribution of low width is preferred. Particularly preferred seed particles thereamong have a monomodal particle size distribution. The seed particles may in principle be constructed from monomers that form elastomeric polymers, examples of such monomers being 1,4-butadiene or acrylates, or from a polymer whose glass transition temperature is more than 0° C., preferably more than 25° C. Preferred monomers for basing these seed particles include vinylaromatic monomers such as styrene, ring-substituted styrenes or α-methylstyrene, including preferably styrene, acrylonitrile, alkylacrylic acid, alkyl acrylates, including preferably n-butyl acrylate. Mixtures of two or more, preferably exactly two, of the monomers mentioned are also suitable.

Seed particles from polystyrene or n-butyl acrylate are particularly preferred. The preparation of seed particles of this type is known to a person skilled in the art or can be carried out according to methods known per se. The seed particles are preferably obtained by particle-forming heterogeneous methods of polymerization, preferably by emulsion polymerization. The seed particles are initially charged according to the present invention for which it is possible for the seed particles to be first separately prepared, worked up and then used. But it is also possible for the seed particles to be formed and then, without prior workup, to be admixed with the monomer mixture of C-11, C-12 and optionally C-13.

Processes for partial or complete agglomeration of grafting base C1 are known to a person skilled in the art. Agglomeration can be carried out according to methods known per se to a person skilled in the art (see for instance Keppler et al. Angew. Markomol. Chemie, 2, 1968 No. 20, pages 1 to 25). The agglomeration method is not subject to any in-principle limitation. Physical methods such as freeze agglomeration or pressure agglomeration processes can thus be used. But chemical methods can also be used to agglomerate the grafting base. The latter include the admixture of electrolytes or of organic or inorganic acids.

Preference is given to agglomeration by means of an agglomeration polymer. Examples of agglomeration polymers are polyethylene oxide polymers, polyvinyl ethers or polyvinyl alcohols. Suitable agglomeration polymers further include copolymers comprising C₁-C₁₂ alkyl acrylates or C₁-C₁₂ alkyl methacrylates or polar comonomers such as acrylamide, methacrylamide, ethylacrylamide, n-butylacrylamide, maleamide or (meth)acrylic acid. These monomers aside, these copolymers can also be constructed from further monomers, including dienes such as butadiene or isoprene. Agglomeration polymers can have a multistage construction and can have, for example, a core/shell construction. The core may be, for example, a polyacrylate such as polyethyl acrylate, while the shell may be particles on alkyl (meth)acrylates and the polar comonomers mentioned. A particularly preferred agglomeration polymer is a copolymer formed from 92 to 99 wt % of ethyl acrylate or methacrylate and 1 to 8 wt % of (meth)acrylamide and/or (meth)acrylic acids. Agglomeration polymers are generally used in the form of a dispersion. The agglomeration process utilizes in general from 0.1 to 5, preferably from 0.5 to 3, parts by weight of the agglomeration polymers per 100 parts by weight of the grafting base.

Graft copolymers C of the present invention can be further used as obtained in the reaction mixture, for example as latex emulsion or dispersion. Alternatively—and this is preferable for most applications—they can also be worked up in a further step. Workup measures are known to a person skilled in the art. They include, for example, graft copolymers C being isolated from the reaction mixture, for example by spray drying, shearing or by precipitation with strong acids or by means of nucleating agents such as inorganic compounds, e.g. magnesium sulfate. However, as-obtained graft copolymers C can also be worked up by complete or partial dewatering. Another possibility is to work up by means of a combination of the measures referred to. The mixing of components B and C to form the molding composition can be effected in any desired manner by known methods.

When these components have been formed by emulsion polymerization, for example, it is possible for the polymer dispersions obtained to be mixed with one another, then to conjointly precipitate the polymers and to work up the polymer mixture. Preferably, however, these components are blended by being conjointly extruded, kneaded or rolled, for which the components have been isolated beforehand as necessary from the as-polymerized solution or aqueous dispersion. However, the graft copolymerization product C obtained in aqueous dispersion can also be dewatered only partially and mixed in the form of moist crumb with the hard matrix B, in which case graft copolymers C then dry completely during the mixing.

### Component D:

Component D of the molding compositions according to the present invention comprises a compound of formula (I):

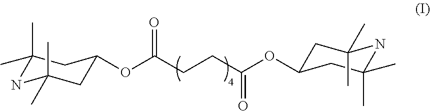

This sterically hindered amine (CAS number 52829-07-9) and its method of making are known to a person skilled in the art and described in the literature (see for example U.S. Pat. No. 4,396,769 and the literature references cited therein). It is marketed by BASF SE under the designation Tinuvin® 770.

Component D is employed in the molding compositions in an amount of 0.2 to 0.9 wt %, preferably 0.2 to 0.7 wt %, often 0.3 to 0.6 wt %.

### Component E:

Component E of the molding compositions according to the present invention comprises a compound or a mixture of compounds of formula (II):

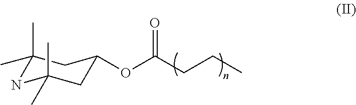

where n is 2 to 20, in particular 7-8.

These sterically hindered amines, such as (CAS number 167078-06-0) and their method of making are known to a person skilled in the art and described in the literature (Carlsson et al., Journal of Polymer Science, Polymer Chemistry Edition (1982), 20(2), 575-82). It is marketed inter alia by Cytec Industries with the repeat units n=7-8 under the designation Cyasorb® 3853 (CAS number 167078-06-0).

Component E is employed in the molding compositions in an amount of 0.2 to 0.7 wt %, preferably 0.2 to 0.5 wt %, often 0.2 to 0.4 wt %.

### Component F:

Component F of the molding compositions according to the present invention may be a compound of formula (III) or a mixture of the compounds:

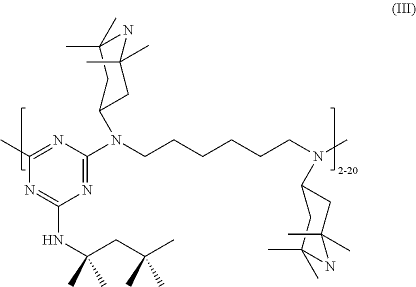

This sterically hindered amine (CAS number 71878-19-8) and its method of making are known to a person skilled in the art and described in the literature (see for example EP-A 093 693 and the literature references cited therein). It is marketed by BASF SE under the designation Chimassorb® 944.

Component F of the molding compositions according to the present invention may further be a compound of formula (IV) or a mixture:

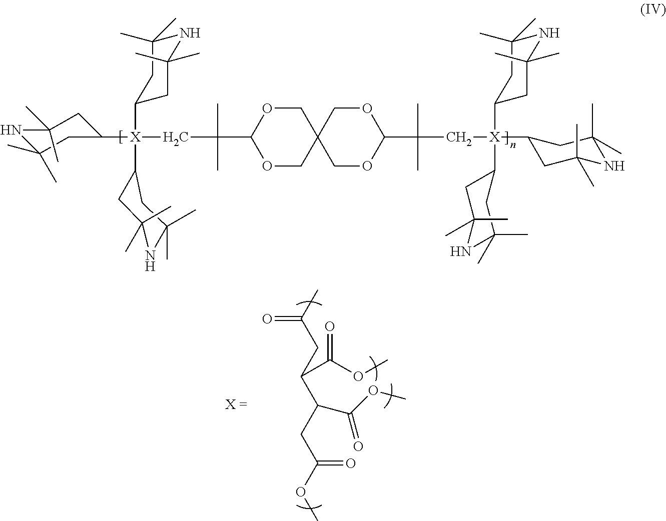

where n=2 to 20.

This sterically hindered amine (CAS number 101357-37-3) and its method of making are known to a person skilled in the art and described in the literature (see for example U.S. Pat. No. 5,208,132 and the literature references cited therein). It is marketed by ADEKA under the designation Adeka Stab® LA-68.

Component F of the molding compositions according to the present invention may further be a compound of formula (V) or a mixture:

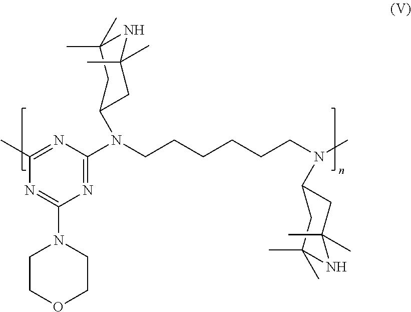

where n=2 to 20.

This sterically hindered amine (CAS number 82451-48-7) and its preparation are known to a person skilled in the art and described in the literature (see for example U.S. Pat. No. 4,331,586 and the literature references cited therein). It is marketed by Cytec Industries under the designation Cyasorb® UV-3346.

Component F of the molding compositions according to the present invention may further be a compound of formula (VI) or a mixture:

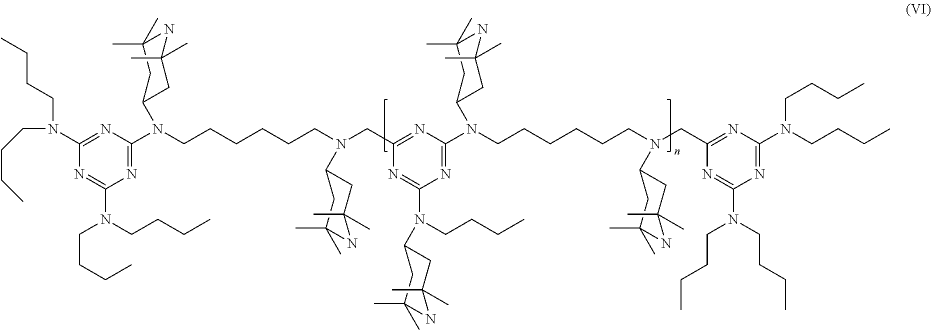

where n=2 to 20.

This sterically hindered amine (CAS number 192268-64-7) and its method of making are known to a person skilled in the art and described in the literature (see for example EP-A-782 994 and the literature references cited therein). It is marketed by BASF SE under the designation Chimassorb® 2020.

### Component G:

Any known customary phosphorus-containing flame retardant can in principle be used as component G. The flame retardants recited in DE-A 40 34 336 and/or EP-A 522 397 are used with preference.

Examples are tri-(2,6-dimethylphenyl)phosphate, triphenyl phosphate, tricresyl phosphate, diphenyl 2-ethylcresyl phosphate, diphenyl cresyl phosphate, tri(isopropylphenyl)phosphate and also diphenyl 4-phenylphenyl phosphate, phenyl bis(4-phenylphenyl)phosphate, tris(4-phenylphenyl)phosphate, diphenyl benzylphenyl phosphate, phenyl bis(benzylphenyl)phosphate, tris(benzylphenyl)phosphate, diphenyl(1-phenylethyl)phenyl phosphate, phenyl bis(1-phenylethyl)phenyl phosphate, tris(1-phenylethyl)phenyl phosphate, diphenyl(1-methyl-1-phenylethyl)phenyl phosphate, phenyl bis(1-methyl-1-phenylethyl)phenyl phosphate, tris((1-methyl-1-phenylethyl)phenyl)phosphate, phenyl bis(4-(1-phenylethyl)-2,6-dimethylphenyl)phosphate, diphenyl 2,4-dibenzylphenyl phosphate, diphenyl 2,4-di(1-phenylethyl)phenyl phosphate and diphenyl 2,4-di(1-methyl-1-phenylethyl)phenyl phosphate. They can also be used in admixture with triphenylphosphine oxide or tri(2,6-dimethylphenyl)phosphine oxide.

Preferred flame retardants also include resorcinol diphosphate and correspondingly higher oligomers, hydroquinone diphosphate and corresponding higher oligomers. The phosphorus compounds recited in EP-A 103 230, EP-A 174 493, EP-A 206 058, EP-A 363 608 and EP-A 558 266 are also referenced.

Triphenyl phosphate is often employed in the molding compositions in amounts of 0 to 10 wt % as component G.

### Component H:

In addition to components A, B, C, D, E, F and G, the molding compositions according to the present invention may comprise one or more additives/added-substance, materials other than components D, E, F and G and as typical and customary for mixtures of plastics.

Examples of such additives/added-substance materials are: dyes, pigments, colorants, antistats, antioxidants, stabilizers to improve thermal stability, to increase light stability, to enhance hydrolysis resistance and chemical resistance, agents against thermal decomposition and in particular the lubricants/glidants that are useful for production of moldings and/or molded articles. These further added-substance materials may be admixed at every stage of the manufacturing operation, but preferably at an early stage in order to profit early on from the stabilizing effects (or other specific effects) of the added-substance material. Heat stabilizers and oxidation retarders are typically metal halides (chlorides, bromides, iodides) and are derived from metals of group I of the periodic table (such as Li, Na, K, Cu).

Stabilizers useful as component H include the customary hindered phenols, but also “vitamin E” and/or similarly constructed compounds. Benzophenones, resorcinols, salicylates, benzotriazoles and other compounds are also suitable. These are typically used in amounts of 0 to 2 wt %, preferably 0.01 to 2 wt % (based on the overall weight of molding compositions according to the present invention).

Often the molding compositions contain no further stabilizers but 0 to 5 wt % of additives, such as carbon black, as component H.

Suitable gliding and demolding agents include stearic acids, stearyl alcohol, stearic esters and/or generally higher fatty acids, their derivatives and corresponding fatty acid mixtures having 12 to 30 carbon atoms. Use levels for these additions—if present—range from 0.05 to 1 wt % (based on the overall weight of molding compositions according to the present invention).

Useful added-substance materials further include silicone oils, oligomeric isobutylene or similar materials, typical usage levels—if present—ranging from 0.05 to 5 wt % (based on the overall weight of molding compositions according to the present invention). Pigments, dyes, color brighteners, such as ultramarine blue, phthalocyanines, titanium dioxide, cadmium sulfides, derivatives of perylenetetracarboxylic acid can likewise be used.

Processing aids and stabilizers, lubricants and antistats are typically used in amounts of 0 to 2 wt %, preferably 0.01 to 2 wt % (based on the overall weight of molding compositions according to the present invention).

### Component I:

Component I of the molding compositions according to the present invention may optionally also comprise fibrous or particulate fillers (or mixtures thereof) other than components D, E, F, G and H. It is preferable for commercially available products to be concerned here, for example carbon fibers and glass fibers. Usable glass fibers may be of E-, A- or C-glass, and are preferably finished with a sizing agent and a coupling agent. Their diameter is generally between 6 and 20 μm. Not only continuous-filament fibers but also chopped glass fibers (staple) or rovings having a length of 1 to 10 mm, preferably 3 to 6 mm, can be used.

It is further possible for filling and reinforcing materials, such as glass beads, mineral fibers, whiskers, alumina fibers, mica, quartz flour and wollastonite, to be added.

In addition to components A, B, C, D, and optionally E, F, G, H, I, the molding compositions according to the present invention may comprise further polymers.

The process of producing the molding compositions of the present invention from the components can be carried out in any desired manner by any known method. Preferably, however, the components are blended by melt mixing, for example conjoint extrusion, kneading or rolling of the components, for example at temperatures in the range from 160 to 400° C., preferably from 180 to 280° C., wherein, in a preferred embodiment, the components have first been partially or completely isolated from the reaction mixtures obtained in the particular steps of the production process. For example, graft copolymers C can be mixed in the form of moist crumb with pellets of vinylaromatic copolymer B, in which case complete drying to the graft copolymers described then takes place during mixing.

The components may be supplied, each in pure form, to suitable mixing devices, in particular extruders, preferably twin-screw extruders. However, individual components, for example B and C, can also be first premixed and then mixed with further components B or C or other components, for example D and E. Component B may be employed as a component which is produced separately beforehand; however it is also possible for the acrylate rubber and the vinylaromatic copolymer to be dosed independently from one another. In one embodiment, a concentrate, for example of components C and D in component B, is prepared first (to obtain a masterbatch or an additive batch) and then mixed with the desired amounts of the remaining components. The molding compositions may be processed by methods known to those skilled in the art to form pellets, for example, or else be processed directly to form molded articles, for example.

The molding compositions of the present invention may be processed to form self-supporting films or sheets, molded articles or fibers. These self-supporting films or sheets, molded articles or fibers are suitable for use in particular in the outdoor sector, i.e., under weathering conditions.

These self-supporting films or sheets, molded articles or fibers are obtainable from the molding compositions of the present invention by the known methods of thermoplastic processing. More particularly, their production can take the form of thermoforming, extrusion, injection molding, calendering, blow molding, compression molding, press sintering, deepdrawing or sintering, preferably by injection molding.

The molding compositions of the present invention versus the known stabilized molding compositions have a further improved resistance to weathering, i.e., a further improved resistance to heat, light and/or oxygen.

The invention is more particularly described by the examples and claims.

### A) Methods of Measurement:

Impact strengths of products were determined at (−30°) C. on ISO bars to ISO 179 1/eU. Tensile stress at yield was determined to ISO 527 at 23° C.

To obtain a measure of weathering resistance, test specimens (60×60×2 mm, produced to ISO 294 in a family mold at a melt temperature of 260° C. and a mold temperature of 60° C.) were subjected to weatherization by xenon-arc test to ISO 4892/2, method A, outside. The samples were not subjected to any additional treatment after weatherization. Following the 1500 h weatherization time referred to in table 1 (“BWZ”), the surface gloss of all samples was measured to German standard specification DIN 67530 at a 60° viewing angle and the surface was evaluated in terms of the gray scale (5: no change, 1: massive change) to ISO 105-A02 (1993).

To obtain a further measure of weathering resistance, penetration was determined on small plaques (60×60×2 mm, produced to ISO 294 in a family mold, at a melt temperature of 260° C. and a mold temperature of 60° C.) to the ISO 6603-2 standard at room temperature (20° C.).

### Materials Used for the Experiments:

The components or products with a prefixed “V-” are not in accordance with the present invention, they are offered for comparison.

The following were used as component A (or as component V-A for comparison):
A-i: Makrolon® 2205 polycarbonate from Bayer with an Mw of 18 300 g/mol measured using SEC-MALLS (Chi-san Wu, Handbook of size exclusion chromatography and related techniques, volume 91, chapter 21, page 19).
A-ii: Makrolon® 2405 polycarbonate from Bayer with an Mw of 21 100 g/mol measured using SEC-MALLS (Chi-san Wu, Handbook of size exclusion chromatography and related techniques, volume 91, chapter 21, page 19).
V-A-iii a Moplen® HP500N polypropylene commercially available from LyondellBasell Industries AF S.C.A.
V-A-iv: a Polystyrol® 158K polystyrene commercially available from BASF SE (or Styrolution GmbH).

The following were used as components B:
B-i: a styrene-acrylonitrile copolymer having an acrylonitrile content of 19% and a chain length of 134 000 measured using SEC-MALLS (Chi-san Wu, Handbook of size exclusion chromatography and related techniques, volume 91, chapter 21, page 19).
B-ii: a styrene-acrylonitrile copolymer having an acrylonitrile content of 25% and a chain length of 171 000 measured using SEC-MALLS (Chi-san Wu, Handbook of size exclusion chromatography and related techniques, volume 91, chapter 21, page 19).

The following were used as component C (or V-C for comparison):
C-i: a grafted acrylate rubber synthesized as described in the invention example of EP-A-450 485, as component B-i. Component B-i was synthesized with 2 parts of dihydrodicyclopentadienyl acrylate (CAS number 12542-30-2) instead of 2 parts of tricyclodecenyl acrylate.
   C-i₁: 16 parts of butyl acrylate and 0.4 part of dihydrodicyclopentadienyl acrylate were heated under agitation to 60° C. in 150 parts of water and the presence of one part of the sodium salt of a C₁₂-C₁₈ paraffinsulfonic acid, 0.4 part of potassium persulfate, 0.3 part of sodium bicarbonate and 0.15 part of sodium pyrophosphate. 10 minutes after the start of the reaction, a mixture of 82 parts of butyl acrylate and 1.6 parts of dihydrodicyclopentadienyl acrylate was added over 3 hours. Thereafter the reaction mixture was additionally left alone for one hour. The latex obtained had a solids content of 40 wt %. The average particle size was determined as 92 nm. The particle size distribution was narrow (quotient Q=0.33).
   C-i₂: an initial charge of 2.5 parts of the latex prepared as described in C-i₁ was admixed with 50 parts of water and 0.1 part of potassium persulfate followed in the course of 3 hours by a mixture of 49 parts of butyl acrylate and 2 parts of dihydrodicyclopentadienyl acrylate and also by a solution of 0.5 part of the sodium salt of a C₁₂-C₁₈ paraffinsulfonic acid in 25 parts of water. At this stage the temperature of the initial charge was 60° C. On completion of the addition the system was postpolymerized for 2 hours. The latex obtained had a solids content of 40%. The average particle size was determined as 526 nm. The particle size distribution was narrow (quotient Q=0.16).
   C-i₃: 150 parts of the latex obtained according to C-i₂ were mixed with 20 parts of styrene and 60 parts of water and under agitation heated to 65° C. for 3 hours after addition of a further 0.03 part of potassium persulfate and 0.05 part of lauroyl peroxide. The dispersion obtained was polymerized with 20 parts of a mixture of styrene and acrylonitrile in a ratio of 75:25 for a further 4 hours and precipitated with calcium chloride solution, the precipitate was separated off, washed with water and dried in a warm stream of air. The degree of grafting of C-i was determined as 35%, the average particle size was determined as 624 nm.

The swelling index of C-i in toluene was found to be 13.6.
V-C-ii: prepared like component C-i, except with 5 parts of dihydrodicyclopentadienyl acrylate in C-i₁ and C-i₂ instead of 2 in each case. B-i was found to have a swelling index in toluene of 4.9. The average particle size was determined as 653 nm. The particle size distribution was narrow (SI=0.14).
V-C-iii: a grafted acrylate rubber having a particle size of 1207 nm. Prepared from component C-i₂.
V-C-iii₁: an initial charge of 9.4 parts of the latex prepared as described in C-i₂ was admixed with 50 parts of water and 0.1 part of potassium persulfate followed in the course of 3 hours by a mixture of 49 parts of butyl acrylate and 2 parts of dihydrodicyclopentadienyl acrylate and also by a solution of 0.5 part of the sodium salt of a C₁₂-C₁₈ paraffinsulfonic acid in 25 parts of water. At this stage the temperature of the initial charge was 60° C. On completion of the addition the system was postpolymerized for 2 hours. The latex obtained had a solids content of 40%. The average particle size was determined as 1065 nm.
V-C-iii₂: 150 parts of the latex obtained according to C-i₂ were mixed with 20 parts of styrene and 60 parts of water and under agitation heated to 65° C. for 3 hours after addition of a further 0.03 part of potassium persulfate and 0.05 part of lauroyl peroxide. The dispersion obtained was polymerized with 20 parts of a mixture of styrene and acrylonitrile in a ratio of 75:25 for a further 4 hours and precipitated with calcium chloride solution, the precipitate was separated off, washed with water and dried in a warm stream of air. The degree of grafting of C-i was determined as 35%, the average particle size was determined as 1207 nm.

The swelling index of V-C-iii in toluene was found to be 9.

The following were used as component D (or V-D for comparison):
D-i: a compound of formula (I), commercially available from BASF SE under the designation Tinuvin® 770.
V-D-ii: a compound of formula (VII), commercially available from BASF SE under the designation Tinuvin® 765.

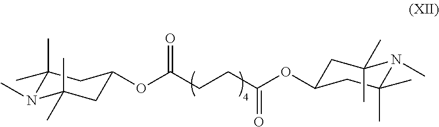

The following was used as component E:
E-i: a compound of formula (II), commercially available from Cytec Industries under the designation Cyasorb® 3853, where in formula (II) n is preferably 7 to 8.

The following were used as component F (or V-F for comparison):
F-i: a compound of formula (III), commercially available from BASF SE under the designation Chimassorb® 944.
V-F-iii: a high molecular weight sterically hindered amine of formula (VIII), CAS number 106990-43-6, commercially available from SABO S.p.A. under the designation Sabostab® 119.

The following was used as component G:
G-i: a commercially available (e.g., Lanxess Germany) triphenyl phosphate (CAS number 115-86-6), marketed under the designation Disflamoll TP.

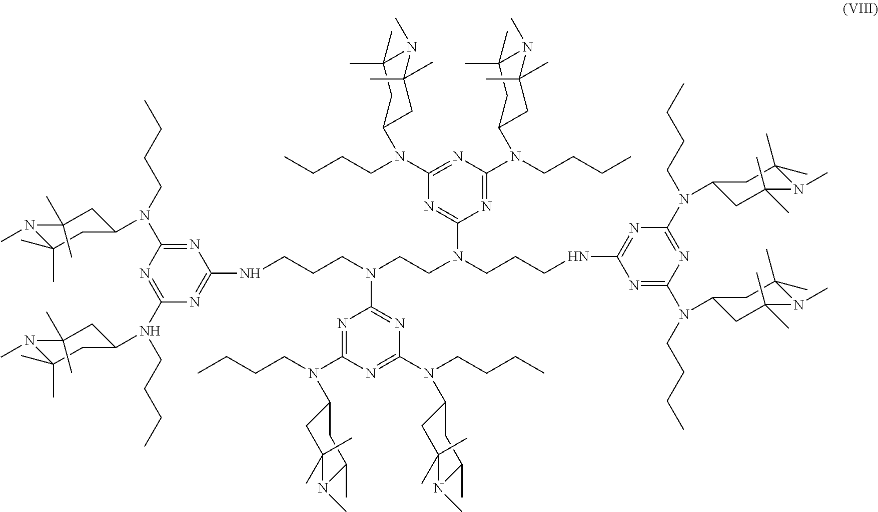

The following was used as component H:
H-i: Black Pearls 880 carbon black commercially available from Cabot Corporation (Boston USA).

Producing the Molding Compositions and Molded Articles

The components A, B, C, D, E, F, H and G (see table 1 for respective parts by weight) were homogenized at 280° C. in a twin-screw extruder (ZSK30 from Werner & Pfleiderer) and extruded therefrom into a water bath. The extrudates were pelletized and dried. The pellets of the molding compositions were used to injection mold at 260° C. melt temperature and 60° C. mold surface temperature various test specimens to determine the properties referred to in table 1 before and after weatherization.

TABLE 1
Ingredient line up and properties of molding compositions
(prefixed V: for comparison)

| Ingredient | Example | | | | | | | | | | |
|---|---|---|---|---|---|---|---|---|---|---|---|
| lineup | 1 | 2 | 3 | V-4 | V-5 | V-6 | 7 | V-8 | V-9 | V-10 | 11 |
| A-i | 58 | — | 58 | 59 | 58 | 58 | 58.2 | — | — | — | 58 |
| A-ii | — | 73 | — | — | — | — | — | — | — | — | — |
| V-A-iii | — | — | — | — | — | — | — | 98.8 | — | — | — |
| V-A-iv | — | — | — | — | — | — | — | — | 98.8 | 98 | — |
| B-i | 20 | — | 15 | 20 | 20 | 20 | 20 | — | — | — | 20.5 |
| B-ii | — | 12.5 | — | — | — | — | — | — | — | — | — |
| C-i | 20 | 12.5 | 15 | 20 | — | 20 | 20 | — | — | — | 20 |
| V-C-ii | — | — | — | — | 20 | — | — | — | — | — | — |
| V-C-iii | — | — | — | — | — | — | — | — | — | — | — |
| D-i | 0.5 | 0.5 | 0.5 | — | 0.5 | — | 0.5 | 0.1 | 0.1 | 0.5 | 0.5 |
| V-D-ii | — | — | — | — | — | 0.5 | — | — | — | — | — |
| E-i | 0.5 | 0.25 | 0.25 | — | 0.5 | 0.5 | — | — | — | 0.5 | — |
| F-i | — | 0.25 | 0.25 | — | — | — | — | 0.1 | 0.1 | — | — |
| F-ii | — | — | — | — | — | — | — | — | — | — | — |
| V-F-iii | — | — | — | — | — | — | 0.3 | — | — | — | — |
| G-i | — | — | 10 | — | — | — | — | — | — | — | — |
| H-i | 1 | 1 | 1 | 1 | 1 | 1 | 1 | 1 | 1 | 1 | 1 |
| aₙ (kJ/m²) | 360 | 330 | 347 | 380 | 276 | 310 | 336 | 12 | 4 | 3 | 342 |
| Tensile stress | 49.9 | 46.9 | 48.8 | 52.2 | 42.4 | 49.3 | 48.2 | 35 | 53 | 54 | 44.7 |
| at yield [MPa] | | | | | | | | | | | |
| gloss after | | | | | | | | | | | |
| 0 h BWZ | 93 | 88 | 90 | 92 | 89 | 93 | 91 | 97 | 1022 | 101 | 91 |
| 1500 h BWZ | 65 | 78 | 72 | 2 | 8 | 18 | 23 | 82 | | 4 | 27 |
| grayness after | | | | | | | | | | | |
| 0 h BWZ | 5 | 5 | 5 | 5 | 5 | 5 | 5 | 5 | 5 | 5 | 5 |
| 1500 h | 3 | 4 | 3.5 | 1 | 1.5 | 1 | 1.5 | 1 | 1 | 1 | 2 |
| BWZ | | | | | | | | | | | |
| penetration | | | | | | | | | | | |
| [Nm] | | | | | | | | | | | |
| 0 h BWZ | 51 | 53 | 55 | 53 | 52 | 50 | 49 | 4 | 1 | 1 | 52 |
| 1500 h BWZ | 51 | 50 | 51 | 12 | 44 | 46 | 48 | 1 | 0 | 1 | 49 |

The examples demonstrate that the inventive molding compositions, comprising at least one polycarbonate, a styrene copolymer and impact-modifying grafted rubber, have an improved resistance to weathering, i.e., an improved resistance to heat, light, and/or oxygen, over the known stabilized molding compositions. The ingredient lineups are reported in weight fractions, the abbreviation BWZ stands for weatherization time. The use of at least one component D (such as Tinuvin 770) and at least one component E (such as Cyasorb 3853) in the compositions prove to be particularly advantageous.

1. A thermoplastic molding composition comprising the following components:
a) 3 to 91.7 wt % of at least one aromatic polycarbonate, as component A
b) 3 to 91.7 wt % of one or more styrene copolymers, as component B
c) 3 to 91.7 wt % of one or more impact-modifying grafted rubbers without olefinic double bonding in the rubber phase, as component C
d) 0.2 to 0.9 wt % of a compound of formula (I), as component D: 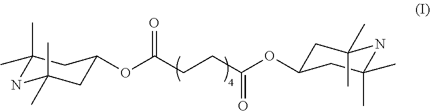
e) 0 to 0.9 wt % of a mixture of formula (II), as component E: 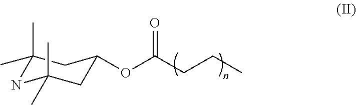
n=2 to 20
f) 0 to 0.9 wt % of a compound of formula (III), as component F: 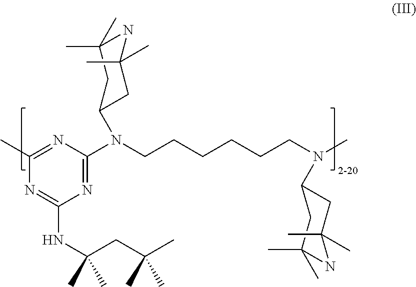
or 0 to 0.9 wt % of a compound of formula (IV): 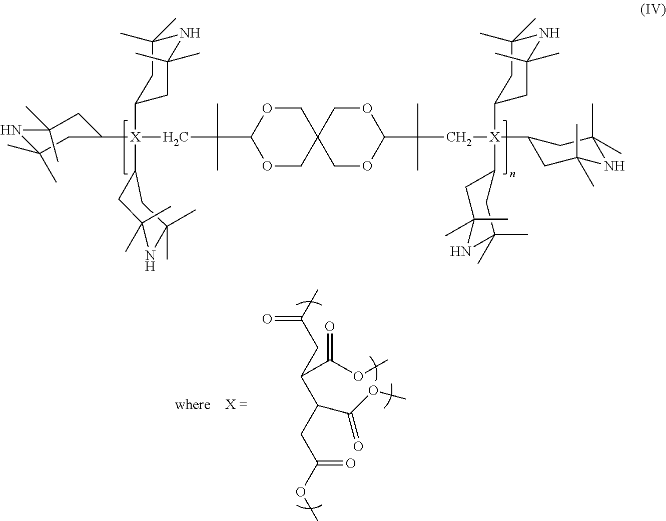
where n=2 to 20
or 0 to 0.9 wt % of a compound of formula (V): 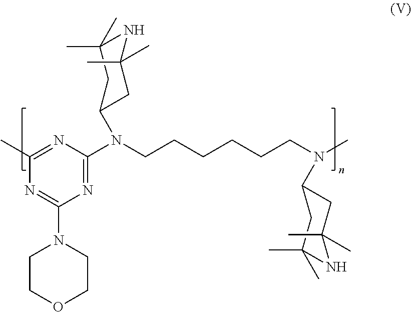
where n=2 to 20
or 0 to 0.9 wt % of a compound of formula (VI): 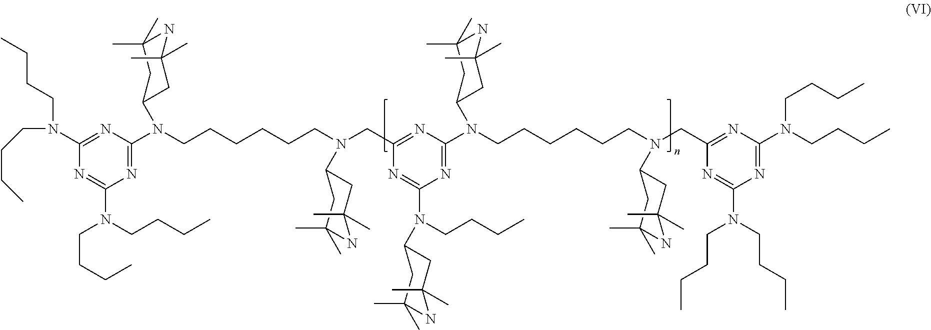
where n=2 to 20
g) 0 to 25 wt % of at least one halogen-free phosphorous compound G
h) 0 to 10 wt % of one or more added-substance materials other than components D, E, F and G, as component H, and
i) 0 to 40 wt % of fibrous or particulate fillers, as component I,
with the proviso that when component E amounts to 0 wt %, at least one of the components of formulae (III), (IV), (V) or (VI) is present in an amount of 0.01 to 0.9 wt %, wherein the wt % are each based on the overall weight of components A to I, and these add up to 100 wt %.

2. The thermoplastic molding composition according to claim 1, characterized in that the swelling index of component C is in the range from 6 to 20.

3. The thermoplastic molding composition according to claim 1, characterized in that component B comprises a copolymer of acrylonitrile, styrene and/or a-methylstyrene, phenylmaleimide, methyl methacrylate or mixtures thereof.

4. The thermoplastic molding composition according to claim 1, characterized in that component C comprises a mixture of an acrylate-styrene-acrylonitrile (ASA) graft polymer comprising 55 to 80 wt %, based on C, of an elastomer-crosslinked acrylic ester polymer C1 and 45 to 20 wt %, based on C, of a graft sheath C2 formed from a vinylaromatic monomer and one or more polar, copolymerizable, ethylenically unsaturated monomers, optionally a further copolymerizable, ethylenically unsaturated monomer in a weight ratio of from 80:20 to 65:35.

5. The thermoplastic molding composition according to claim 1, characterized in that in component C component C1 comprises from 0.01 to 20 wt %, preferably from 0.1 to 5 wt %, of a crosslinking monomer, preferably butylene diacrylate, divinylbenzene, butaynediol dimethacrylate, trimethylolpropane tri(meth)acrylate, diallyl methacrylate, diallyl maleate, diallyl fumarate, triallyl methacrylate, triallyl isocyanurate, more preferably diallyl phthalate, allyl methacrylate and/or dihydrodicyclopentadienyl acrylate.

6. The thermoplastic molding composition according to claim 1, characterized in that the average particle diameter of component C is between 50 to 1200 nm.

7. The thermoplastic molding composition according to claim 1, characterized in that the weight ratio of components D and E is in the range from 4:1 to 1:1 and the weight ratio of components E and F is in the range from 2:1 to 0.5:1.

8. The thermoplastic molding composition according to claim 1, characterized in that the molding composition can comprise from 0 to 1.5 wt % of phthalic ester or adipic ester.

9. The thermoplastic molding composition according to claim 1, characterized in that component C1 comprises from 2 to 99 wt % of butyl acrylate.

10. The thermoplastic molding composition according to claim 1, characterized in that the vinylaromatic component in C2 comprises either styrene or a-methylstyrene.

11. The thermoplastic molding composition according to claim 1, characterized in that the ethylenically unsaturated component in C2 comprises acrylonitrile and/or alkyl methacrylates and/or alkyl acrylates having C₁-C₈ alkyl.

12. The thermoplastic molding composition according to claim 1, characterized in that component C comprises a grafted rubber in monomodal or bimodal particle size distribution.

13. A process for producing a thermoplastic molding composition according to claim 1, characterized in that components A to D and, optionally, components E to I are mutually mixed with one another in any desired order at temperatures of 100 to 300° C. and a pressure of 1 to 50 bar, then kneaded and extruded.

14. The process for producing a thermoplastic molding composition according to claim 13, characterized in that first a portion of component C is premixed with a portion of component B in a ratio of 1:1 to 1:2 to form a masterbatch and then mixed with further components A to D and optionally components E to I to form the thermoplastic molding composition.

15. (canceled)

16. (canceled)

17. A molded article, a fiber or a self-supporting film or sheet comprising a thermoplastic molding composition according to claim 1.

18. A molded article, a fiber or a self-supporting film or sheet according to claim 17 in the form of a molded automotive component or electronic equipment part.

19. The thermoplastic molding composition according to claim 1, with the proviso that when component E amounts to 0 wt %, at least one of the components of formulae (Ill), (IV), (V) or (VI) is present in an amount of 0.1 to 0.9 wt %, wherein the wt % are each based on the overall weight of components A to I, and these add up to 100 wt %.

20. The thermoplastic molding composition according to claim 1, with the proviso that when component E amounts to 0 wt %, at least one of the components of formulae (III), (IV), (V) or (VI) is present in an amount of 0.2 to 0.8 wt %, wherein the wt % are each based on the overall weight of components A to I, and these add up to 100 wt %.
